(19) United States
(12) Patent Application Publication
(10) Pub. No.: US 2023/0147217 A1
(43) Pub. Date: May 11, 2023

(54) ELECTRIC MACHINE

(71) Applicant: ZF Friedrichshafen AG, Friedrichshafen (DE)

(72) Inventors: Ulrich Kehr, Tettnang (DE); Tobias Brenner, Bovenden (DE); Michaela Mehlin, Friedrichshafen (DE); Josef Otta, Friedrichshafen (DE); Sabine Sielemann, Deggenhausertal (DE)

(73) Assignee: ZF Friedrichshafen AG, Friedrichshafen (DE)

(21) Appl. No.: 17/996,152

(22) PCT Filed: Mar. 31, 2021
(86) PCT No.: PCT/EP2021/058463

§ 371 Date: Oct. 13, 2022

(30) Foreign Application Priority Data
Apr. 15, 2020 (DE) 10 2020 204 725.1

(51) Int. Cl. H02K 5/24; H02K 5/15

(52) U.S. Cl. CPC H02K 5/24; H02K 5/15

(57) ABSTRACT

An electric motor may have a housing (which may be round), and a rotor that rotates on a rotor shaft, located within that housing. Hinged levers between the housing and the stator may be pivotable radially on the housing. Forces from the stator in the circumferential direction may be transferred rigidly to the housing by the hinged levers. The hinged levers may allow for radial movements and deformations of the stator upon receipt of these forces.

### RELATED APPLICATIONS

This application is a filing under 35 U.S.C. § 371 of International Patent Application PCT/EP2021/058463, filed Mar. 31, 2021, and claiming priority to German Patent Application DE 10 2020 204 725.1, filed Apr. 15, 2020. All applications listed in this paragraph are hereby incorporated by reference in their entireties.

### TECHNICAL FIELD

The present disclosure relates to an electric machine with a round housing, a stator, and a rotor on a rotor shaft. Such an electric machine functions in particular as an electric motor, but can also be used as a generator.

### BACKGROUND

Temporally variable mechanical forces that act on the stator are formed by the magnetic forces in the gap between the stator and the rotor. These forces can be mathematically described as waves that spread out radially as well as tangentially. The waves overlap radially and tangentially with different spatial and temporal arrangements. The radial waves cause the housing to vibrate. The housing vibrations result in acoustic vibrations in the adjacent structures, or form sound waves in the surrounding air.

The stator is normally installed in the housing as rigidly as possible. The radial deformations of the stator cause by magnetic forces are transferred directly to the housing and result is disruptive noises when in operation.

The stator is frequently pressed into the housing or a stator mount. This results in a rigid connection over the entire contact surface area. Alternatively, the stator can be screwed to the end surfaces of the housing at axial holes therein. This results in contact surfaces at the ends, and a rigid connection between the stator and the housing.

### BRIEF DESCRIPTION OF THE DRAWINGS

Exemplary embodiments of the invention shall be explained in greater detail below in reference to the attached drawings. Therein:

FIG. 1 shows a perspective view of an electric motor from the front;

FIG. 2 shows a perspective view of the stator for the electric motor in FIG. 1;

FIG. 3 shows the electric motor in FIG. 1, with the bearing pins partially removed;

FIG. 4 shows the stator for the electric motor in FIG. 2, in an exploded view;

FIG. 5 shows a second electric motor from the front;

FIG. 6 shows a perspective view of the stator for the electric motor from FIG. 5.

### DETAILED DESCRIPTION

In view of the background above, a fundamental problem addressed by the present disclosure is how to attach the stator in an electric machine to the housing such that the impact on the housing by the radial deformations of the stator resulting from radial forces is kept to a minimum.

In some aspects, this problem is solved according to the first claim through fastening elements which rigidly connect the stator to the housing in the circumferential direction, but exhibit a radial flexibility. The torques in the stator are rigidly transferred to the housing by the fastening means according to the invention, while these fastening means remain flexible when reacting to radial deformations of the stator, such that the deformations are not transferred to the housing, or are extremely dampened. The fastening elements result in a rigid connection in the circumferential, or tangential, direction, but are flexible in the radial direction.

In particular, the fastening elements transfer compressive and tensile forces from the stator to the housing in the circumferential direction, but only allow a limited radial movement of the stator in relation to the housing. As a result of this anisotropic property of the fastening elements, there is the same non-rotating connection between the stator and the rotor as with conventional electric machines, but the radial forces coming from the stator have only a minimal impact on the housing. This results in less vibration and a significant noise reduction.

In a preferred embodiment of the electric machine according to the invention, the fastening elements are formed by hinged levers placed between the housing and the stator, which can pivot radially on the housing. By way of example, the shaft of the hinged lever extends circumferentially, or in the tangential direction, and has pivot heads at each end. The hinged levers allow for small radial movements of the stator, but rigidly connect the stator to the housing in the circumferential direction, transmitting compressive and tensile forces from the stator to the housing in a tangential direction.

The hinged levers can be advantageously supported on the housing at one pivot head and on the stator at the other pivot head. These pivot heads can pivot about an axis that is parallel to the axis of the rotor. Alternatively, the desired anisotropic properties of the hinged levers can be obtained through the material selection, or a combination of materials with different mechanical properties. By way of example, the fastening elements can be made of an elastic material, preferably an elastomer. The desired differences in stiffness in the radial direction and in the circumferential direction can be obtained through the geometric design. The fastening elements can also be composite components made of metal and rubber. The fastening elements can also be formed by hinged levers in which the pivot heads are coated with an elastomer. The elastomer part would then exhibit the desired deformability or flexibility in the radial direction.

The stator in the electric machine preferably comprises a packet of stator plates, in the manner known per se. The stator plates have radially protruding eyelets. Bearing pins are placed in the eyelets, extending parallel to the rotor shaft. The hinged levers serving as fastening elements are attached to the bearing pins at one end and to the housing at the other end. These bearing pins extend axially all the way through the packet of stator plates, but are not rigidly connected to the housing in the radial direction. The pivotal connection of the other pivot head to the housing is preferably obtained through a socket formed on the end surface of the housing.

To obtain a rotationally symmetrical support for the stator in the housing, numerous hinged levers can be distributed evenly about the circumference of the stator. There are preferably four to eight, particularly preferably six, hinged levers evenly distributed about the circumference of each end of the housing.

Instead of hinged levers between the housing and the stator, the fastening elements can also be formed as an integral part of the stator. With a stator comprised of a packet of stator plates, the fastening elements can be formed by radial slits on the circumference of the stator plates, and these radial slits can partially overlap and border on narrow plate webs that can bend radially. The plate webs do not bend in the circumferential direction, or tangential direction, but they do bend in response to radial waves, and the radial deformations of the stator caused by them. The radial slits therefore prevent a spreading of the radial waves to the adjacent plate webs in the radial direction on the stator plates, and thus effectively decouple the housing from the vibrations in the stator.

The stator ideally has numerous radial slits distributed evenly over its circumference. Four to eight radial slits, which overlap by approximately one third, forms an optimal compromise between rigidity of the outer edge of the stator along the circumference, and flexibility in the radial direction.

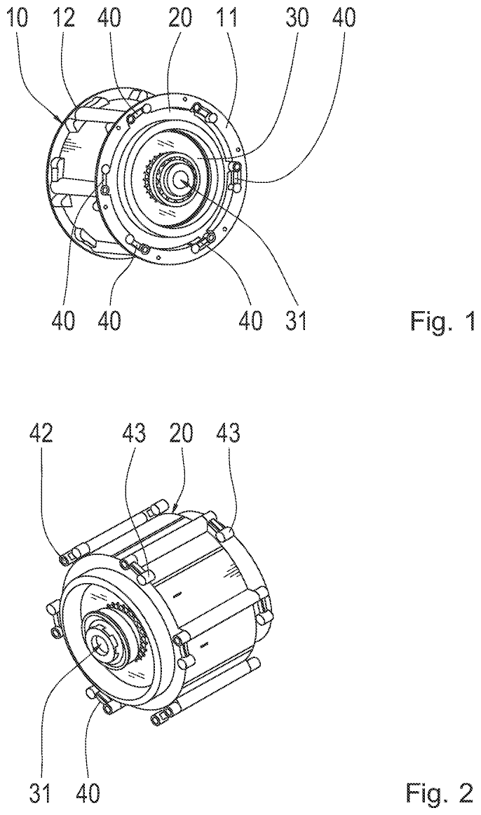

The simplified illustration of the electric motor in FIG. 1 has a cylindrical housing 10 in which a stator 20 is placed such that it cannot rotate. A concentric rotor 30 rotates inside the stator 20. There are hinged levers 40 between the stator 20 and the rotor 30.

The front end surface 11 and rear end surface 12 of the housing 10 form flanges. Round sockets 13 are formed at the transition between the end surfaces 11, 12 and the cylindrical housing wall. Beads 14 protrude radially outward between the front end surface 11 and the rear end surface 12.

The stator 20 comprises a packet of stator plates 21 with eyelets 22 that protrude radially outward thereon (see FIG. 4).

The rotor 30 rotates on a rotor shaft 31 that can rotate in the housing 10. The rotor shaft 31 forms the motor shaft for the electric motor. Because the rotor 30 is on the inside, and the stator 20 is on the outside, this design is referred to as an internal rotor. The opposing magnetic attractive forces and repelling forces between the stator 20 and the rotor 30 cause the rotor shaft 31 to rotate.

As can be readily seen in FIG. 4 in particular, the hinged levers 40 each have a shaft 41 that extends tangentially, and pivot heads 42 and 43 on the ends of the shaft 41. There are six hinged levers 40 on each of the end surfaces 11, 12, evenly distributed over the circumference of the stator 20.

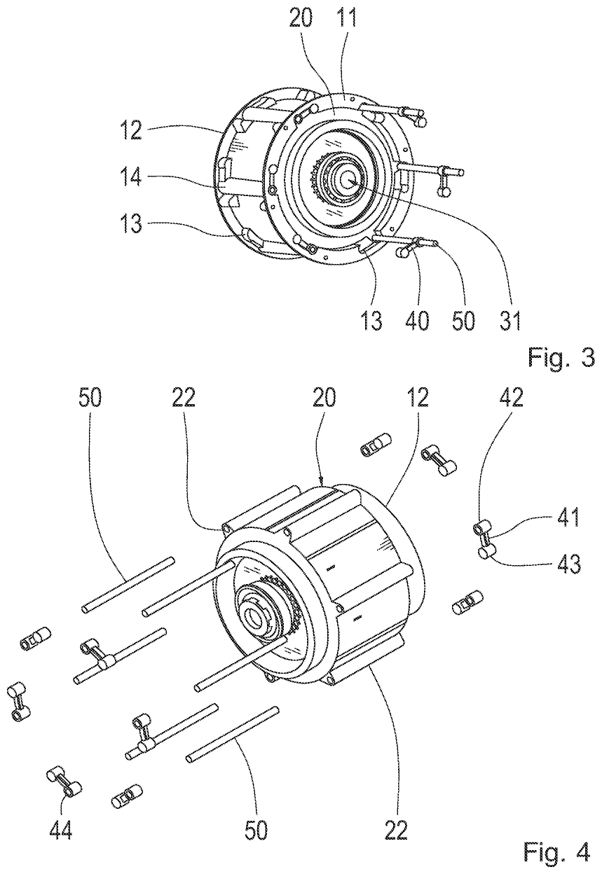

There are bearing pins 50 in the eyelets 22 on the stator plates 21, which extend parallel to the rotor shaft 31 in the axial direction. The bearing pins 50 sit in the corresponding beads 14 on the housing 10. The hinged levers 40 are pivotally connected at their first pivot heads 42 on the axial ends of the bearing pins 50 (see FIG. 3, FIG. 4). The pivot heads 43 on the other ends of the hinged levers 40 are pivotally supported in the sockets 13 on the housing 10.

The rigid but pivotally supported hinged levers 40 rigidly connect the stator 20 to the housing 10 in the circumferential direction, but form a flexible connection in the radial direction. Tangential compressive and tensile forces in the stator 20 are thus transferred rigidly to the housing 10 in the circumferential direction, while the eyelets 200 on the stator plates 21 can move slightly in the radial direction in the sockets 14 formed on the housing 10. The hinged levers 40 therefore react in a flexible manner to radial deformations of the stator 20. Radial waves are therefore not transferred from the stator 20 to the housing 10.

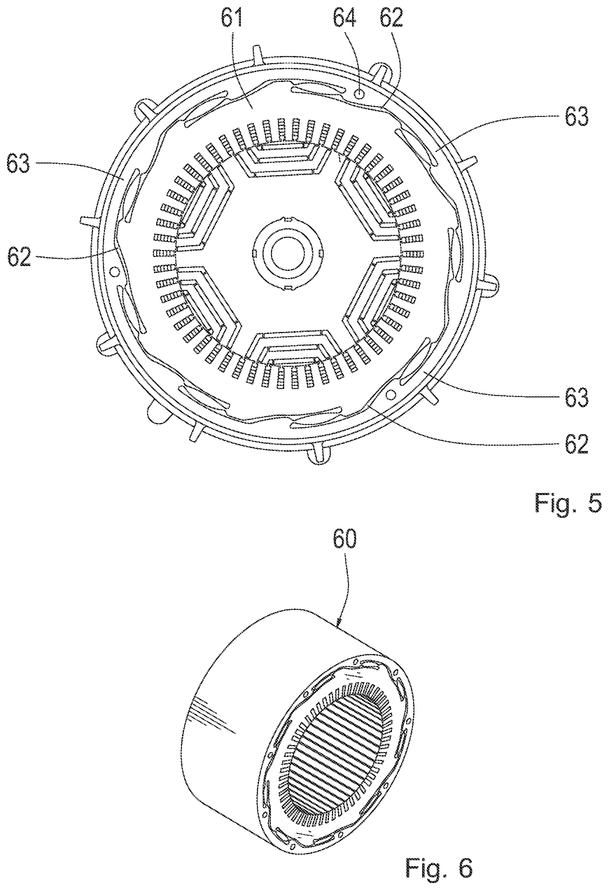

In the second embodiment of an electric motor, shown in FIGS. 5 and 6, the stator also comprises a packet of parallel stator plates 61. The stator plates 61 have radial slits 62 on their outer edges that are evenly distributed over the entire circumference of the stator 60. The radial slits 62 are partially overlapping, and border on narrow plate webs 63. There are fastening holes 64 for bearing pins (not shown), which extend axially through the stator. Radial deformations of the stator 60 are compensated for by the radial slits 62. The relatively narrow plate webs 63 on the stator plates 61 can give slightly in the radial direction by bending in an elastic manner.

The words “comprising” and “having” in the claims do not exclude the presence of other elements. The indefinite articles “a” or “one” do not exclude the existence of a plurality. A single element can carry out the functions of numerous elements specified in the claims.

### REFERENCE SYMBOLS

10 housing
11 end surface
12 end surface
13 socket
14 bead
20 stator
21 stator plate
22 eyelet
30 rotor
31 rotor shaft
40 hinged lever
41 shaft
42 pivot head
43 pivot head
44 hole (in (42)
50 bearing pin
60 stator
61 stator plate
62 radial slit
63 plate web
64 fastening hole

1. An electric machine, comprising:
a housing,
a stator located in the housing that is fixed from rotation relative to the housing,
a rotor that rotates on a rotor shaft, and
at least one fastening element that connects the stator to the housing such that the connection is rigid in a circumferential direction, and such that the connection is flexible in a radial direction.

2. The electric machine according to claim 1, wherein the at least one fastening element includes a plurality of fastening elements, and wherein the fastening elements transfer compressive and tensile forces from the stator to the housing in the circumferential direction without preventing radial movement.

3. The electric machine according to claim 2, wherein the fastening elements are hinged levers that are located between the housing and the stator, and the fastening elements are pivotable in the radial direction relative to the housing.

4. The electric machine according to claim 3, wherein the hinged levers have a shaft extending in a tangential direction, and wherein the hinged levers respectively have pivot heads on the ends of the shaft.

5. The electric machine according to claim 4, wherein the hinged levers are pivotally attached to the housing at a first set of the pivot heads and to the stator at a second set of the pivot heads, the first set of the pivot heads and the second set of the pivot heads being distinct.

6. The electric machine according to claim 5, wherein the pivot heads are pivotable about an axis parallel to the rotor shaft.

7. The electric machine according to claim 6, wherein the stator comprises a packet of stator plates, the stator plates having radially protruding eyelets wherein bearing pins are located at least partially within in the eyelets on the stator plates, and wherein the bearing pins extend parallel to the rotor shaft.

8. The electric machine according to claim 4, wherein the housing has sockets respectively engaged with the pivot heads.

9. The electric machine according to claim 3, wherein a plurality of hinged levers are evenly distributed about the circumference of the stator.

10. The electric machine according to claim 9, wherein four to eight hinged levers are located on each of the two end surfaces.

11. The electric machine according to claim 1, wherein the stator comprises a packet of stator plates, and wherein the stator plates have radial slits on their circumferences that are partially overlapping and border on narrow plate webs that are bendable in an elastic manner in the radial direction.

12. The electric machine according to claim 11, wherein a plurality of radial slits are evenly distributed over the circumference of the stator.

13. The electric machine according to claim 1, wherein the housing is round.

14. The electric machine according to claim 10, wherein six hinged levers are located on each of the two end surfaces.
